(19) United States
(12) Patent Application Publication
(10) Pub. No.: US 2010/0182331 A1
(43) Pub. Date: Jul. 22, 2010

(54) METHOD AND APPARATUS FOR DRAWING IMAGE

(75) Inventor: Tae Hoon LEE, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/687,167

(22) Filed: Jan. 14, 2010

(30) Foreign Application Priority Data
Jan. 16, 2009 (KR) 10-2009-0003769

(51) Int. Cl. G09G 5/36

(52) U.S. Cl. 345/545

(57) ABSTRACT

An image drawing method and apparatus using an off-screen buffer are disclosed. The method includes: creating an off-screen buffer including a first region and a second region; drawing a fixed image of images to be displayed on the first region; copying the first region on which the fixed image is drawn to the second region; drawing a moving image of the images to be displayed on the second region; and copying the second region on which the moving image is drawn to a frame buffer.

### CLAIMS OF PRIORITY

This application claims priority to an application entitled “METHOD AND APPARATUS FOR DRAWING IMAGE” filed in the Korean Intellectual Property Office on Jan. 16, 2009 and assigned Serial No. 10-2009-0003769, the contents of which are incorporated herein by reference.

### BACKGROUND OF THE INVENTION

1. Field of the Invention

The present invention relates generally to a method and an apparatus for drawing an image in a system and, more particularly, to a method of drawing an image in a system using an off-screen buffer of a JAVA application and an apparatus for performing the same.

2. Description of the Related Art

In a typical display system, an image is temporally stored in a frame buffer before projecting the image to a screen directly. The system creates a memory buffer region called an off-screen buffer and draws images in the memory buffer region. After all of the image drawings are completed, the system then transmits data of the off-screen buffer simultaneously. This method is called “double buffering” and is generally used in most systems including displays. That is, in a double buffering process, the frame buffer contains the on-screen data displayed on the display device while the off-screen buffer holds the partially or fully rendered contents of the next screen update to be displayed.

Applications based on Java, owing to their general purpose and simplicity, are widely used in computers, embedded systems, and mobile devices. As functional demands for multimedia are gradually increasing in systems with the Java application, various types of graphic data must be processed faster and in improved ways. Currently, Java basically provides a basic application interface (API) in which an application itself may create an off-screen buffer to realize double buffering. Using this feature, the Java program can draw pictures in the buffer.

FIG. 6 is a flowchart illustrating the performance of image drawing on an off-screen buffer using a double buffering process. When drawing is requested (610), an application creates an off-screen buffer (620). The application performs the drawing of a graphic object on the created off-screen buffer (630). The graphic object may include an image, text, and various other figures. In order to prevent a graphic object drawn on a foreground from being covered by another graphic object that is drawn on a background, the application draws graphic objects background first. The application makes a copy of the drawn image to a frame buffer and the copy of the drawn image is output onto a display (640). The application determines whether a finally-drawn image corresponds to a final image and completes the drawing when the finally-drawn image is the final image (650). When the finally-drawn image does not correspond to the final image, the application clears the off-screen buffer (660) and performs the image drawing on the cleared off-screen buffer (630).

The application repeatedly performs the above processes to draw continuous images sequentially. When the continuous images do not have commonness and considerably different images are sequentially drawn, the above processes may be repeated. However, when a partially modified image is drawn, the repetition of the above processes may deteriorate the drawing efficiency.

FIG. 7 shows a screen provided to change a specific image 720 into another image 722 when a background image 710 is fixed. In this case, when the above processes are performed, after the background image 710 and the specific image 720 are drawn, the off-screen buffer is cleared and the background image 710 and another image 722 must be drawn on the cleared off-screen buffer again. Hence, the background image 710 must be drawn repeatedly during the drawing.

In general, when the image drawing is performed, complicated calculations are performed simultaneously, and time for the drawing must be increased during such calculations. Particularly, the larger an image takes more time to be drawn. As illustrated in FIG. 7, the background image 710 occupies the most area of the whole image, and the images 720 and 722 to be modified have a very small area. In other words, most of the time for drawing of the whole image is spent drawing the background image 710 repeatedly. Thus, there is a need for a new way of processing the double buffering.

### SUMMARY OF THE INVENTION

Therefore, the present invention provides a method of reducing time for drawing a plurality of images having an identical fixed image and improving drawing efficiency.

The present invention provides a drawing method of reducing drawing time in an off-screen buffer in a system using the off-screen buffer of a Java application and of improving drawing efficiency.

The present invention also provides an apparatus using the drawing method.

In accordance with the aspects of the present invention, there is provided a method of drawing an image, including: creating an off-screen buffer including a first region and a second region; drawing a fixed image of images to be displayed on the first region; copying the first region on which the fixed image is drawn to the second region; drawing a moving image of the images to be displayed on the second region; and copying the second region on which the moving image is drawn to a frame buffer.

The method further includes separating the images to be displayed into the fixed image and the moving image.

In the method, when another image having an identical fixed image is requested to be drawn, copying the first image, drawing a moving image, and copying the second region to the frame buffer are sequentially repeated.

The copying the first region is performed using copyArea( ) predefined in Java application interface (API).

The present invention also provides an apparatus for drawing an image in an off-screen buffer, including a drawing controller to create the off-screen buffer separated into a first region and a second region and to separate images to be displayed into a fixed image and a moving image.

The drawing controller draws the fixed image on the first region, copies the first region on which the fixed image is drawn to the second region, draws the moving image on the second region on which the fixed image is drawn, and copies the second region on which the moving image is drawn to the frame buffer.

When images having an identical fixed image are additionally requested to be drawn, the drawing controller copies the first region on which the fixed image is drawn to the second region, draws a moving image of the images to be additionally drawn on the second region to which the first region is copied, and copies the second region on which the moving image is drawn to the frame buffer.

Each of the first region and the second region is equal in size to the frame buffer.

According to the present invention, owing to the memory copying of the logically expanded off-screen buffer, performance of drawing a full-screen image may be improved and time to perform drawing may be shortened. Therefore, screen flickering may be prevented from occurring when an application is executed that frequently updates the screen rapidly and repeatedly.

### BRIEF DESCRIPTION OF THE DRAWINGS

The above features and advantages of the present invention will be more apparent from the following detailed description in conjunction with the accompanying drawings, in which:

FIG. 1 is a block diagram illustrating an image drawing apparatus according to an exemplary embodiment of the present invention;

FIG. 2 is a logical block diagram illustrating an image drawing method according to an exemplary embodiment of the present invention;

FIG. 3 is a flowchart illustrating an image drawing method according to an exemplary embodiment of the present invention;

FIG. 4 is a flowchart illustrating an image drawing method according to another exemplary embodiment of the present invention;

FIG. 5A shows a frame buffer used in an exemplary embodiment of the present invention;

FIG. 5B shows an off-screen buffer used in an exemplary embodiment of the present invention;

FIG. 6 is a flowchart illustrating a method of performing drawing on an off-screen buffer using a double buffering method according to an exemplary embodiment of the present invention; and

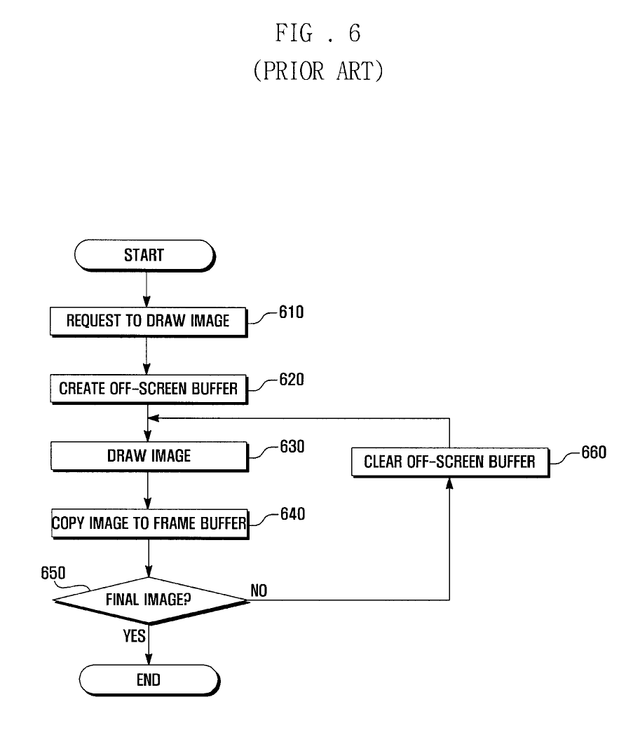

FIG. 7 shows a screen in which a specific image is changed into another image when a background image is fixed in an exemplary embodiment of the present invention.

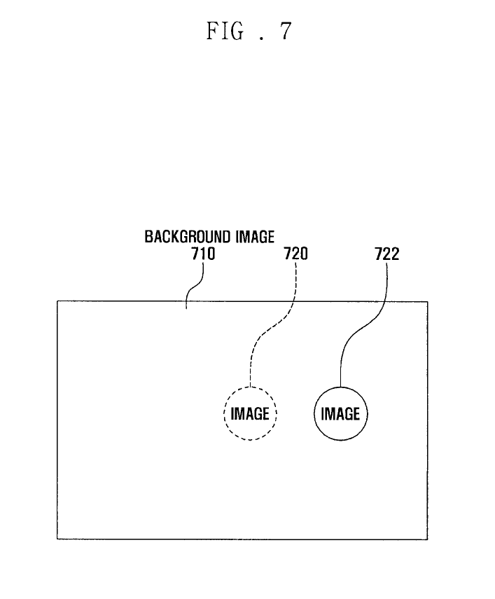

### DETAILED DESCRIPTION OF THE INVENTION

Throughout the description, the term ‘off-screen buffer’ refers to a memory region of a VRAM that is not used in displaying an object on a display. The off-screen buffer may correspond to a memory region of memories in a main memory in association with the display. In exemplary embodiments of the present invention, the off-screen buffer is separated into a first region and a second region. The first and second region have the same size as that of a frame buffer and are logically distinguished in a single off-screen buffer.

The term ‘frame buffer’ refers to a storage device to temporally store image information to be displayed on a screen using raster scanning. A graphic processor receives a display list from the CPU and writes the display list to the frame buffer. Respective memory units of the frame buffer may correspond one to one to pixels of a screen to be displayed without change. In the exemplary embodiments of the present invention, the second region of the off-screen buffer is copied to the frame buffer. The image copied to the frame buffer is output onto a display.

The term ‘drawing’ refers to an operation of drawing a graphic object such as an image, a figure, and text in the off-screen buffer. After the off-screen buffer is created, the drawing of the graphic objects is input into the created off-screen buffer. In the exemplary embodiments, a fixed image is drawn on the first region of the off-screen buffer and a moving image is drawn on the second regions.

The term ‘clear’ refers to an operation of erasing data remaining in the off-screen buffer and filling the off-screen buffer with RGB color code (0, 0, 0). Only the second region of the off-screen buffer may be cleared or both of the first and second regions may be cleared simultaneously.

Hereinafter, exemplary embodiments of the present invention are described in detail with reference to the accompanying drawings. The same reference symbols are used throughout the drawings to refer to the same or like parts. For the purposes of clarity and simplicity, detailed descriptions of well-known functions and structures incorporated herein may be omitted to avoid obscuring the subject matter of the present invention.

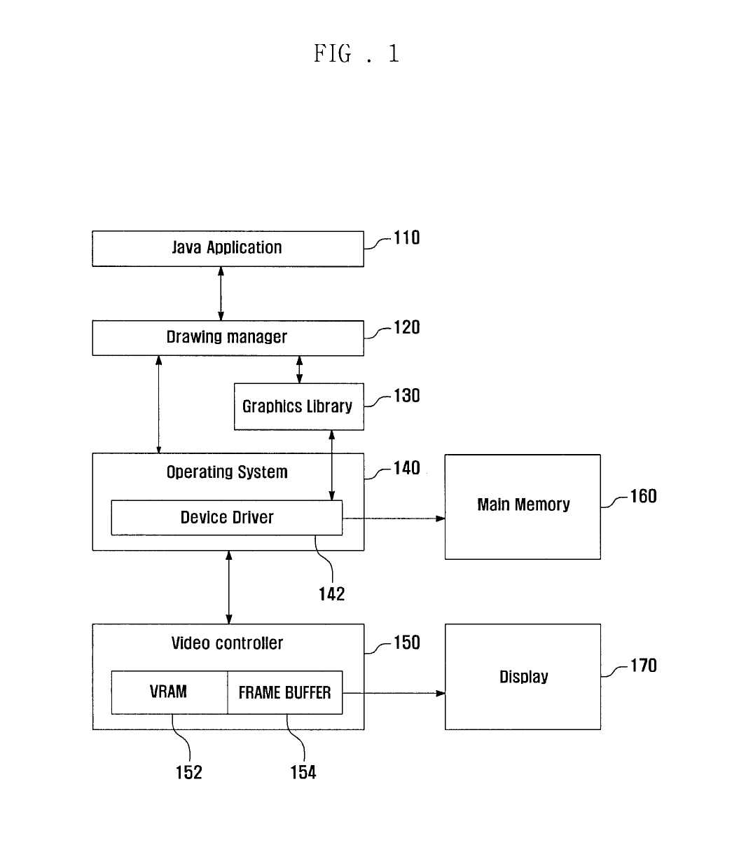

FIG. 1 is a block diagram illustrating an image drawing apparatus according to an exemplary embodiment of the present invention.

Referring to FIG. 1, a Java application 110 requests a drawing manager 120 to draw an image. In response to the request for the image to be drawn from the Java application 110, the drawing manager 120 creates an off-screen buffer and performs the image drawing using basic commands provided from an operating system 140 and functions provided from a graphics library 130. The drawing manager 120 according to the exemplary embodiment of the present invention separates a first logical region and a second logical region of the off-screen buffer when creating the off-screen buffer. The first and second regions may have the same size as that of a frame buffer 154. The drawing manager 120 distinguishes images to be displayed on a display 170 into a fixed image and a moving image. The drawing manager 120 draws the fixed image on the first region of the off-screen buffer, copies the first image on which the fixed image drawn to the second region, and draws the moving image on the second region to which the fixed image is copied.

The drawing manager 120 may be separated from or may be included in the Java application 110. In this case, the drawing manager 120 substitutes a drawing operator of the Java application 110 and the Java application 110 directly transmits and receives a signal to and from the operating system 140 and the graphics library 130.

The graphics library 130 refers to a set of functions defined for graphics. The graphics library 130 may include initializing and setting functions for initializing the graphics library 130 or initially setting a graphics card, basic drawing functions of drawing a point, a line, a circle, an ellipse, and the like, and supplementary functions of describing an image and processing sprites. In an exemplary embodiment of the present invention, the drawing manager 120 performs the image drawing using the functions included in the graphics library 130.

The operating system 140 performs overall control of the image drawing apparatus and includes a device driver 142. The drawing manager 120 uses the device driver 142 to create the off-screen buffer in a video RAM (VRAM) 152 managed by a main memory 160 or a video controller 150.

The video controller 150 having a built-in processor is an image control device to determine a display factor such as a refresh rate, a resolution, and the number of displayable colors. The video controller 150 performs the calculation required to output an image in association with a central processing unit (CPU). In this exemplary embodiment of the present invention, the video controller 150 includes the VRAM 152 and a frame buffer 154 corresponding to a video memory. The VRAM 152 refers to a RAM used in storing data, and the frame buffer 154 refers to a storage device temporally storing image information to be displayed on a screen.

The main memory 160 corresponds to a main storage medium storing a program and data required to operate the image drawing apparatus. In the exemplary embodiment, the drawing manager 120 may create the off-screen buffer in the main memory 160.

The display 170 visually provides a program, data, function setting information, and other various information that is included in the image drawing apparatus to a user. The display 170 may be a liquid crystal display (LCD), a cathode ray tube (CRT), a plasma display panel (PDP), and other devices capable of displaying an image. The display 170 outputs data copied into the frame buffer 154.

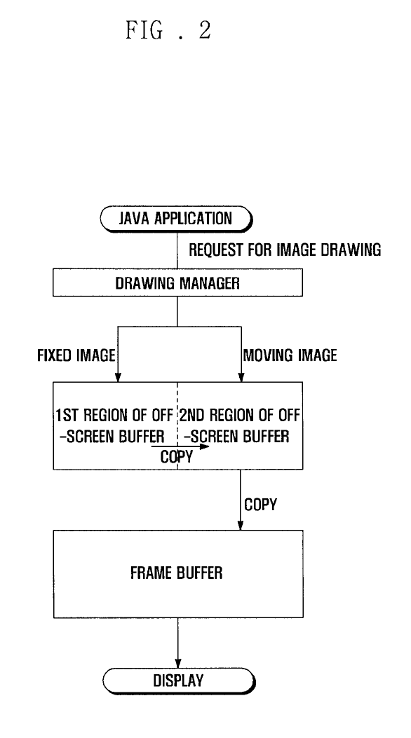

FIG. 2 is a logical block diagram illustrating an image drawing method according to an exemplary embodiment of the present invention.

Referring to FIG. 2, the Java application 110 requests the drawing manager 120 to draw an image. The drawing manager 120 separates a fixed image and a moving image from the image requested to be drawn. When the requested image is an image of a moving picture, a plurality of images is continuously displayed on the display 170. The drawing manager 120 analyzes the plurality of images to be displayed on the display 170 and separates the fixed image and the moving image. The drawing manager 120 creates the off-screen buffer in the main memory 160 or the VRAM 152. The off-screen buffer is separated into a first region and a second region, wherein the drawing manager 120 draws the fixed image on the first region of the off-screen buffer. In this exemplary embodiment, the drawing manager 120 may create the off-screen buffer first and may separate the fixed image and the moving image. The drawing manager 120 copies the image drawn in the first region to the second region. After that, the drawing manager 120 draws the moving image on the second region to which the fixed image is copied. When the drawing manager 120 copies the second region on which the moving image is drawn to the frame buffer 154, the frame buffer 154 outputs the copied image to the display 170. Thereafter, the drawing of the fixed image on the first region is omitted, but the fixed image drawn on the first region is duplicated onto the second region and only the moving image is drawn on the fixed image duplicated on the second image. In the present invention, the fixed image and the moving image are separated from each other and the fixed image is drawn on the first region once only, so that it is possible to reduce time required to draw the fixed image repeatedly.

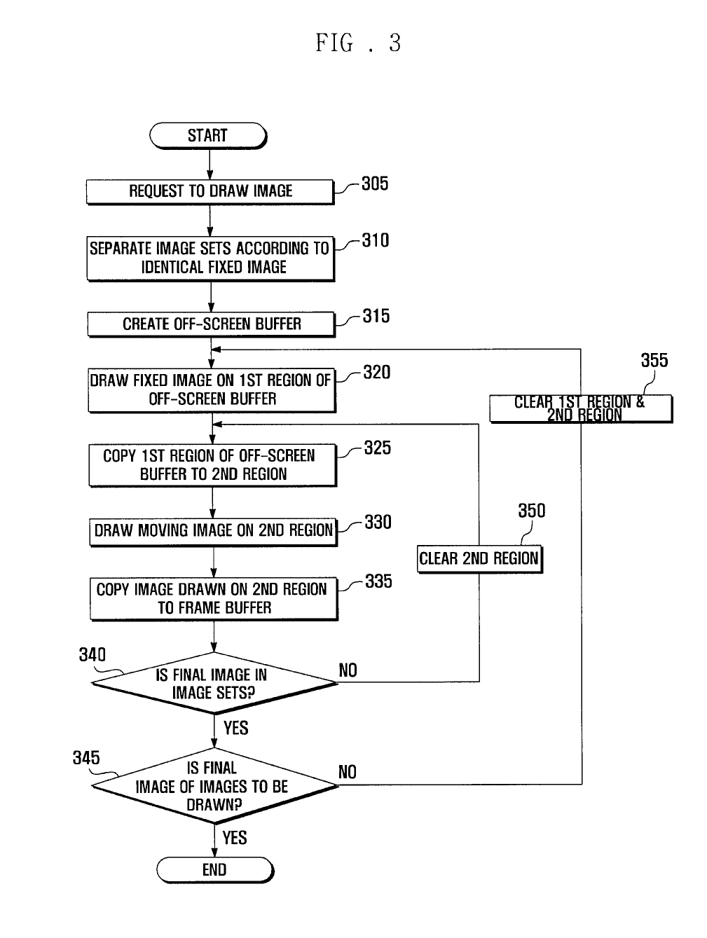

FIG. 3 is a flowchart illustrating an image drawing method according to an exemplary embodiment of the present invention.

Referring to FIG. 3, the drawing manager 120 receives a request for the image drawing from the Java application 110 (305). The drawing manager 120 separates a set of images based on an identical fixed image (310). The fixed image always occupies a preset area without change of coordinate and shape during the execution of a program and most background images are fixed images. In other words, the drawing manager 120 analyzes overall data about the images requested to be drawn by the Java application 110 and groups the images according to the identical images. For example, when drawing images of a moving picture in which a scene is shifted from a bird flying in the sky to a rabbit hopping on a mountain, a sky image and a mountain image may be fixed images. In this case, the drawing manager 120 groups images having the sky image in common into one image set and other images having the mountain image in common into another image set.

Data used in drawing an image may include an identification ID indicating the fixed image. That is, when the Java application is created, the ID corresponding to the fixed image may be included in the Java code. In this case, the drawing manager 120 may group an image set according to the identical fixed image using the ID of the data to be used in drawing images before the image drawing. For example, when an ID matching the sky image is set to ‘1’, data required to draw images including the sky image in common includes the ID ‘1’. Likewise, when an ID matching the mountain image is set to ‘2’, data required to draw images including the mountain image in common includes the ID ‘2’. The drawing manager 120 groups the images using the data including the ID ‘1’ into one image set and the images using the data including the ID ‘2’ into another image set.

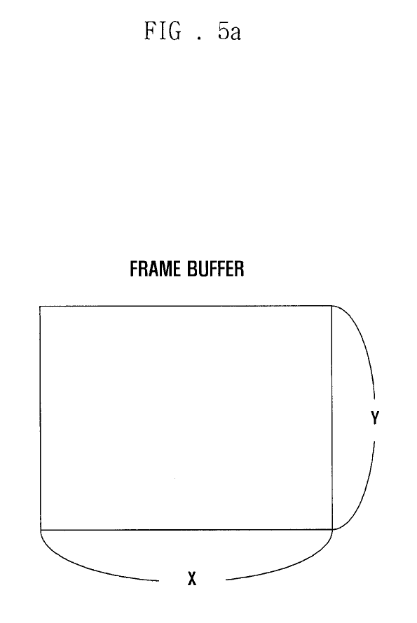

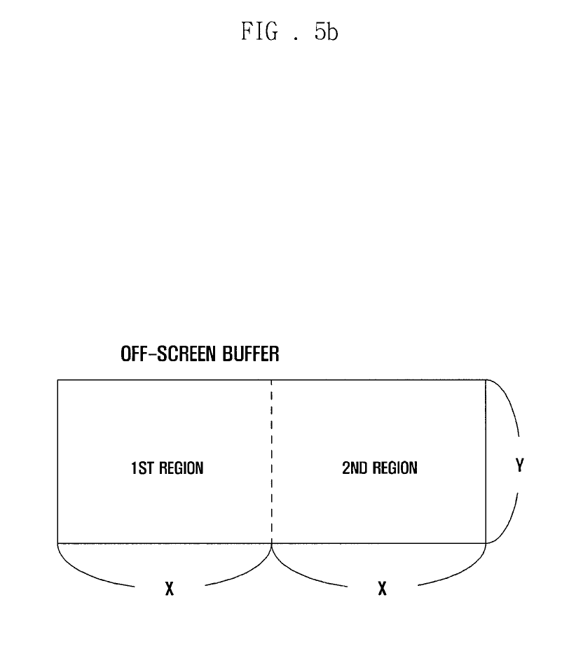

The drawing manager 120 creates the off-screen buffer (315). The off-screen buffer is twice the size of the frame buffer 154. For example, when the frame buffer 154 has a size of 640*480, the drawing manager 120 creates an off-screen buffer having a size of 1280*480 or 640*960. FIG. 5A shows the frame buffer 154 and FIG. 5B shows the off-screen buffer. FIG. 5A shows a frame buffer having a width X and a height Y and FIG. 5B shows an off-screen buffer having a width 2X and a height Y. That is, the off-screen buffer has a size two times the size of the frame buffer.

The drawing manager 120 separates the created off-screen buffer into the first region and the second region. For example, when the frame buffer 154 has a size of 640*480 and the created off-screen buffer has a size of 1280*480, the first region ranges from X-Y coordinates (1, 1) to (640, 480) and the second region ranges from X-Y coordinates (641, 1) to (1280, 480).

The drawing manger 120 draws the fixed image on the first region of the off-screen buffer (320). Using the above-mentioned example, the drawing manager 120 draws the sky image on the first region. Next, the drawing manager 120 copies the image drawn on the first region to the second region (325). The copying (325) is performed using a ‘copyArea( )’ function predefined the in Java API. The ‘copyArea( )’ function is used to copy a memory region in an identical physical off-screen buffer. Since the drawing manager 120 creates an off-screen buffer having twice the size of the frame buffer 154 and separates the off-screen buffer into two logical regions, the copying of the first region of the off-screen buffer to the second region corresponds to copying of the memory region on the same physical off-screen buffer.

Differently from a drawing process, a copy process is a simple form of data transfer, and does not require additional calculations and preparation that are inevitably conducted during the image drawing, and is performed at a faster rate than the image drawing. That is, the copy process, instead of repeatedly drawing the fixed image, may increase overall image drawing speed.

The drawing manager 120 draws an additional moving image on the second region to which the fixed image is copied (330). The fixed image is drawn in the second region, and the drawing manager 120 draws an additional moving image on the second region to complete a whole image. Using the above-mentioned example, the drawing manager 120 additionally draws a new image on the sky image copied to the second region. Note that when the moving image is smaller than the fixed image in size, time for drawing the moving image is shorter than time for drawing the fixed image.

The drawing manager 120 makes a copy of the image drawn on the second region to the frame buffer 154 (335). The drawing manager 120 determines whether a finally-drawn image corresponds to a final image of the image set (340). Using the above-mentioned example, the drawing manager 120 determines whether an image drawn immediately prior corresponds to a final image of the images including the sky image in common. When the image drawn immediately prior does not correspond to the final image of the image set, the drawing manager 120 clears the second region and maintains the fixed image drawn in the first region (350). Then, the drawing manager repeats step 325 thru step 335. Here, when the drawn fixed image is maintained without clearing and the first region is copied to the second region as in step 325, time for repeatedly drawing the fixed image on the first region may be reduced.

When the image drawn immediately prior corresponds to the final image of the image set (340), the drawing manager 120 determines whether the image drawn immediately prior corresponds to a final image of the images requested to be drawn (345). The images requested to be drawn are classified into several image sets and the drawing manager 120 draws the respective image sets. The drawing manager 120 clears the first region and the second region of the off-screen buffer only when new image sets will be drawn without finishing the drawing of entire images requested to be drawn (355). Since the fixed image is modified, the clearing of the first and second regions serves to newly draw the modified fixed image on the first region. Using the above-mentioned example, the fixed image is modified from the sky image to the mountain image. The drawing manager 120 recognizes the modification of the fixed image and clears both the first region and the second region.

The drawing manager 120 draws the fixed image on the first region of the off-screen buffer (320). Then, the drawing manager 120 copies the first region to the second region (325) draws a moving image on the second region (330), and copies the second region on which the moving image is drawn to the frame buffer (335). When the drawings of entire image sets are completed (345), the drawing manager 120 finishes the image drawing.

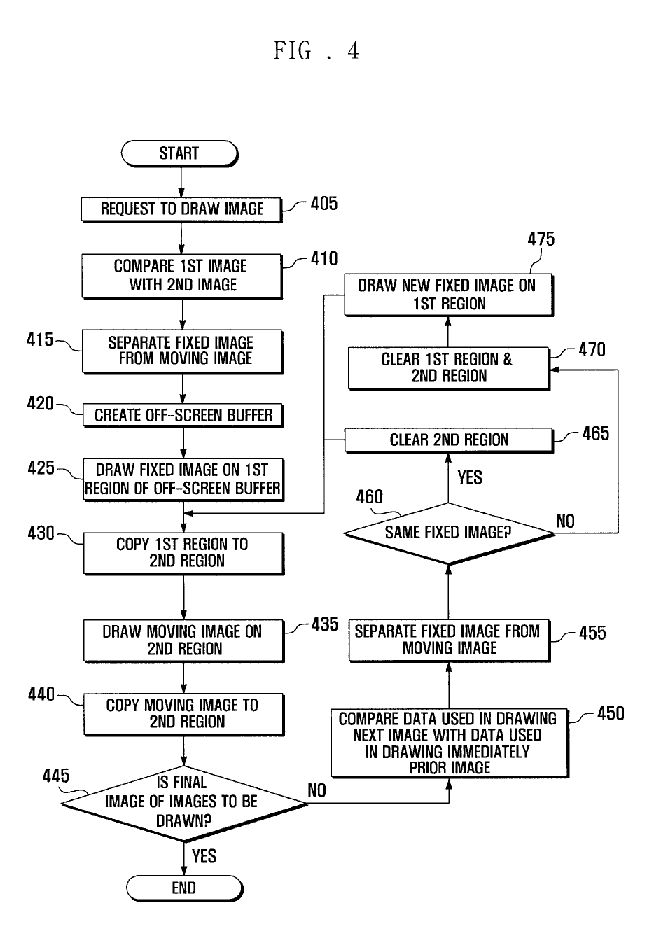

FIG. 4 is a flowchart illustrating an image drawing method according to another exemplary embodiment of the present invention. Briefly, in the image drawing method according to another exemplary embodiment of the present invention, data required to draw an image are compared image by image to separate images to be displayed into a fixed image and a moving image.

Referring to FIG. 4, the drawing manager 120 receives a request for image drawing from the Java application 110 (405). The drawing manager 120 compares data used in drawing a first image of the images to be drawn with data used in drawing a second image (410). Note that the compared data is a characteristic data that each pixel contains respectively. The drawing manger 120 obtains differences from the comparison of the data used in drawing the respective images and separates the images to be displayed into the fixed image and the moving images (415).

The drawing manager 120 creates an off-screen buffer (420). The off-screen buffer is set to twice the size of the frame buffer 154. The drawing manager 120 separates the created off-screen buffer into a first region and a second region.

The drawing manager 120 draws the fixed image on the first region of the off-screen buffer (425). Then, the drawing manager 120 copies the image drawn on the first region to the second region (430). The ‘copyArea( )’ function predefined in the Java API is used for this copy process.

The drawing manager 120 draws the moving image on the second region to which the fixed image is copied (435). The fixed image is drawn on the second region and the drawing manager 120 additionally draws the moving image to complete an overall image.

The drawing manager 120 copies the image drawn on the second region to the frame buffer 154 (440). The drawing manager 120 determines whether an image drawn immediately prior corresponds to a final image of the images to be drawn (445). When the image drawn immediately prior does not correspond to the final image (445), the drawing manager 120 compares data used in drawing a next image with data of the image drawn immediately prior (450), and separates the images to be displayed into the fixed image and the moving image (455). Then, the drawing manager 120 determines whether a fixed image between the image to be drawn and the image drawn immediately prior is identical to the fixed image drawn on the first image (460). When the fixed image between the image to be drawn and the image drawn immediately prior is identical to the fixed image drawn on the first region, the drawing manager 120 clears the second region (465) and copies the first region of the off-screen buffer to the second region (430). When the fixed images are identical, the new fixed image is not drawn on the first region and the fixed image drawn on the first image in advance is copied to the second region using the copy process.

When the fixed images are different (460), it means that the fixed image is modified and the drawing manager 120 clears the first region and the second region (470). Then, the drawing manager 120 draws a new fixed image on the first region (475), copies the first region to the second region (430), additionally draws a moving image on the second region (435), and copies the second region on which the moving image is drawn to the frame buffer 154 (440). When the drawing of every image to be drawn is completed (445), the drawing manager 120 finishes the image drawing.

The present invention provides an image drawing method into which an image drawing process and a copy process are merged. The images to be drawn are grouped into a fixed image and moving images, wherein the fixed image is drawn once only. After that, when images having an identical fixed image are drawn, the fixed image is copied to an off-screen buffer by a copy process and only the moving images are additionally drawn on the copied image so that overall time for drawing images may be shortened.

The exemplary embodiments of the present invention are provided for the easy description and understanding of the present invention with specific examples but do not limit the scope of the present invention. It will be appreciated by those skilled in the art that various changes and modifications may be practiced without departing from the spirit of the present invention.

What is claimed is:

1. A method of displaying a plurality of images, comprising:
providing an off-screen buffer including a first region and a second region;
drawing a fixed image to be displayed on the first region;
copying the first region on which the fixed image is drawn to the second region;
drawing a moving image to be displayed on the second region; and
copying the second region on which the moving image is drawn to a frame buffer.

2. The method of claim 1, further comprising separating the images to be displayed into the fixed image and the moving image.

3. The method of claim 1, wherein, when another image identical to the fixed image is drawn, copying the fixed image to the second region, drawing a next moving image in the second region, and copying the second region to the frame buffer.

4. The method of claim 2, wherein the separation of the images to be displayed further comprises separating the images to be displayed into image sets according to identical fixed images.

5. The method of claim 4, wherein, in the separation of the images to be displayed, the image sets are separated by an identification corresponding to the fixed image.

6. The method of claim 2, wherein, in the separation of the images to be displayed, data used in drawing the images are compared with each other, image by image, to separate the images to be displayed into the fixed image and the moving image.

7. The method of claim 1, wherein the copying the first region is performed using copyArea( ) predefined in a Java application interface (API).

8. An apparatus for drawing a plurality of images in an off-screen buffer, comprising a drawing controller to create the off-screen buffer separated into a first region and a second region and to separate images to be displayed into a fixed image and a moving image.

9. The apparatus of claim 8, wherein the drawing controller draws the fixed image on the first region, copies the first region on which the fixed image is drawn to the second region, draws the moving image on the second region on which the fixed image is copied, and copies the second region on which the moving image is drawn to the frame buffer.

10. The apparatus of claim 9, wherein, when images having an identical fixed image are additionally requested to be drawn, the drawing controller copies the first region on which the fixed image is drawn to the second region, draws a next moving image to be additionally drawn on the second region to which the first region is copied, and copies the second region on which the next moving image is drawn to the frame buffer.

11. The apparatus of claim 8, wherein the drawing controller separates the images to be displayed into image sets according to identical fixed images.

12. The apparatus of claim 8, wherein the drawing controller compares data used in drawing the images with each other, image by image, to separate the images to be displayed into the fixed image and the moving image.

13. The apparatus of claim 9, wherein the drawing controller makes a copy of the first region to the second region using a copyArea( ) function provided by a Java application interface (API).

14. The apparatus of claim 8, wherein each of the first region and the second region is equal in size to the frame buffer.

15. The apparatus of claim 8, wherein the first region and the second region are logically separated from each other on the off-screen buffer.
